(19) United States
(12) Patent Application Publication
(10) Pub. No.: US 2014/0324873 A1
(43) Pub. Date: Oct. 30, 2014

(54) METHOD, DEVICE AND RECORDING MEDIUM FOR MANAGING APPLICATION ICON

(71) Applicants: INTELLECTUAL DISCOVERY CO., LTD., Seoul (KR); NEOWIZ GAMES CORPORATION, Seongnam-si (KR)

(72) Inventor: SO WON LEE, Seoul (KR)

(73) Assignees: NEOWIZ GAMES CORPORATION, Seongnam-si (KR); INTELLECTUAL DISCOVERY CO., LTD., Seoul (KR)

(21) Appl. No.: 14/256,465

(22) Filed: Apr. 18, 2014

(30) Foreign Application Priority Data
Apr. 19, 2013 (KR) 10-2013-0043799

(51) Int. Cl. G06F 17/30; G06F 3/0482; G06F 3/0484; G06F 3/0481

(52) U.S. Cl. CPC G06F 17/30598; G06F 3/04817; G06F 3/0482; G06F 3/04842
USPC 707/740

(57) ABSTRACT

In accordance with an exemplary embodiment of the present invention, it is possible to efficiently manage an app icon to be displayed on a screen of the apparatus without receiving a user input, thereby improving user convenience by determining a group for the app icon according to a predetermined classification rule and controlling the app icon to be displayed according to the determined group.

### CROSS-REFERENCE TO RELATED APPLICATION

This application claims under 35 U.S.C. §119 priority to and the benefit of Korean Patent Application No. 10-2013-0043799 filed in the Korean Intellectual Property Office on Apr. 19, 2013, the entire contents of which are incorporated herein by reference.

### BACKGROUND OF THE INVENTION

(a) Field of the Invention

A technique for managing an application icon is provided.

(b) Description of the Related Art

With the advent of a mouse, a function provided by a computer begins to be performed by clicking an object named as an icon.

The icon facilitates an effective access to functions of a computer system and also provides users with intuitive understanding of what function is connected to a corresponding icon by using an appropriate image.

When a user installs a desired application in addition to functions basically installed in a computer system, an icon corresponding to the installed application is automatically displayed on a computer screen. However, as the number of various types of icons is increased, it may be difficult for users to recognize positions of their desired icons.

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment of the present invention provides an app application managing apparatus including: an app information classification controller configured to perform an application classifying process according to application information by referring to a predetermined classification rule; an app icon group determiner configured to determine a group for at least one app icon based on application classifying processing result information; and a display controller configured to control the app icon to be displayed on an apparatus screen based on group determination information related to the app icon.

An embodiment of the present invention provides an app application managing method including: an app information classification step configured to perform an application classifying process according to application information by referring to a predetermined classification rule; an app icon group determining step configured to determine a group for at least one app icon based on application classifying processing result information; and an app icon display control step configured to control the app icon to be displayed on an apparatus screen based on group determination information related to the app icon.

An embodiment of the present invention provides a computer readable recording medium recorded with program for executing an app application managing method, wherein the app application managing method including: an app information classification step configured to perform an application classifying process according to application information by referring to a predetermined classification rule; an app icon group determining step configured to determine a group for at least one app icon based on application classifying processing result information; and an app icon display control step configured to control the app icon to be displayed on an apparatus screen based on group determination information related to the app icon.

An embodiment of the present invention may be capable of efficiently managing the app icon to be displayed on a screen of the apparatus without receiving a user input, thereby improving user convenience.

As described above, in accordance with the embodiments of the present invention, it is possible to provide an effect of efficiently managing the app icon to be displayed on a screen of the apparatus without receiving a user input, thereby improving user convenience.

### BRIEF DESCRIPTION OF THE DRAWINGS

FIG. 1 is a block diagram showing a structure of an app icon managing apparatus in accordance with an exemplary embodiment of the present invention.

FIG. 2 is a flowchart showing an app icon managing method in accordance with the present exemplary embodiment.

FIG. 3 to FIG. 6 are exemplary diagrams showing a screen of the app icon managing apparatus in accordance with the present exemplary embodiment.

FIG. 7 and FIG. 8 are exemplary diagrams showing a screen of an app icon managing apparatus in accordance with another exemplary embodiment of the present invention.

FIG. 9A to FIG. 10C are exemplary diagrams showing a screen of an app icon managing apparatus, displayed with a group identifier in accordance with yet another exemplary embodiment of the present invention.

### DETAILED DESCRIPTION OF THE EMBODIMENTS

Exemplary embodiments of the present invention feature automatically classifying application icons according to a predetermined classification rule and controlling the display of each application icon based on the classification result.

Terms that are used in this specification will be defined before the exemplary embodiments are described.

An icon is an image indicating an application program, a function, a concept, an object having a specific meaning, or the like. The icon is lined to an executable file for executing a specific function, a document file, a music file, or the like. As a result, a linked executable file is executed or a linked document is opened through an input, e.g., by selecting a corresponding icon such as clicking or double-clicking it.

The icon may be combined with any characters to inform users of what information the corresponding icon provides and what function is performed therethrough.

An application indicates a program that corresponds to the corresponding icon to execute a predetermined function, and may be basically installed in an apparatus, or may be directly installed in the apparatus through an application providing server such as a web server related to the corresponding service. In this specification, if necessary, ‘app’ as the abbreviation for the application may also be used.

Hereinafter, exemplary embodiments of the present invention will be described in detail with reference to the accompanying drawings. In adding reference numerals to components of each drawing, even though the same components are illustrated in different drawings, it is to be noted that these components are denoted by the same reference numerals if possible. In describing exemplary embodiments of the present invention, well-known functions or constructions will not be described in detail since they may unnecessarily obscure the understanding of the present invention.

In addition, in describing components of the present specification, terms such as first, second, A, B, (a), (b), etc. may be used. These terms are used only to differentiate the components from other components. Therefore, the nature, times, sequence, etc. of the corresponding components are not limited by these terms. When a component is “connected”, “coupled”, or “linked” to another component, it is to be understood that the component may be directly connected or linked to the other component, but the component may be “connected”, “coupled”, or “linked” to the other component via another component therebetween.

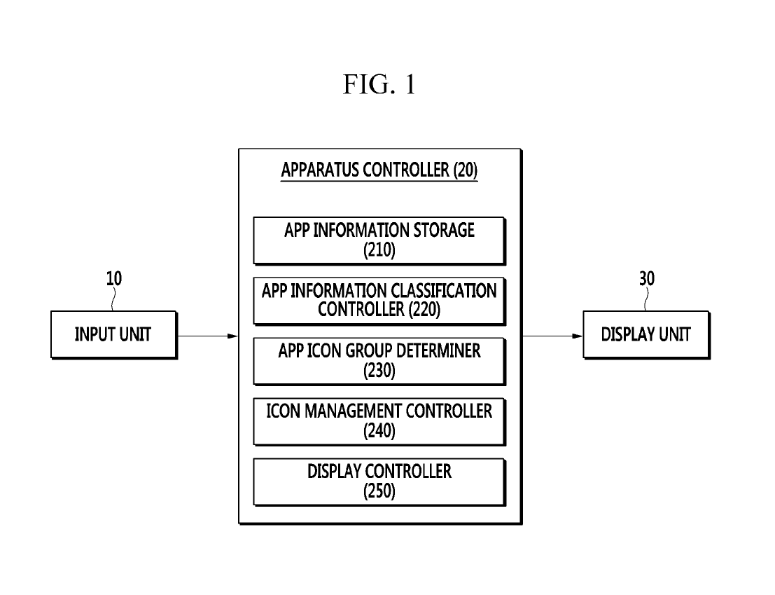

FIG. 1 is a block diagram showing a structure of an app icon managing apparatus in accordance with an exemplary embodiment of the present invention.

Referring to FIG. 1, the app icon managing apparatus in accordance with the present exemplary embodiment includes an app information classification controller 220 for performing an application information classifying process according to application information based on a predetermined classification rule, an app icon group determiner 230 for determining a group for at least one app icon based on result information of the application classifying process, and a display controller 250 for controlling the display of the app icon on a screen thereof based on group determining information of the app icon.

The app icon managing apparatus further includes an icon management controller 240 for controlling general operations of the app information classification controller 220 and the app icon group determiner 230, an app information storage 210 for storing application information corresponding to each application, and a display unit 30 for displaying the app icon on the screen according to the control of the display controller 250.

The app icon managing apparatus of the present exemplary embodiment includes a mobile terminal such as a smart phone, a tablet PC, a personal digital assistant (PDA), and a mobile communication device, and may also include a desk top computer and a lap top computer. However, the app icon managing apparatus is not limited thereto, but may include any information processing device which can perform a specific function.

Application information indicates information related to an application that was already installed or is to be installed in the apparatus. The application information may have different contents according to the classification rule of the app information classification controller 220, but it is preferable that metadata of the application including a writer, a distributor, a genre, contents, authority condition thereof, or data receipt route information (download route information) of the application in the case that the application is received from an external server such as an app store server is applied as the application information. If necessary, usage history information of the application installed in the apparatus may be applied.

Detailed description on the application information will be made later along with the classification rule.

The app icon indicates an icon that is displayed on the screen of the apparatus to correspond to the application that was already installed or is to be installed in the apparatus.

When acquiring application information from the application that was already installed or is installed, the icon management controller 240 stores the acquired application information in the app information storage 210. Further, the icon management controller 240 may control application information corresponding to an application that is deleted and is not installed in the apparatus at all to be deleted in the app information storage.

The app information classification controller 220 may perform the application classifying process on each app icon corresponding to an application that is pre-installed in the apparatus, and may also perform the application classifying process on an app icon that is not classified yet since a corresponding application is newly installed.

The icon management controller 240 may receive selection data of an app icon of which group will be determined according to an application classification process from a user. To that end, the app icon managing apparatus may include an input unit 10 for receiving the selection data from the user.

The icon management controller 240 may form an icon managing interface through which a user can select all or some of the app icons installed in the apparatus and transfers it to the display controller 250, and the display controller 250 may control the transferred icon managing interface to be displayed on the screen of the apparatus through the display unit 30.

When some or all of the app icons installed in the apparatus are selected through the icon managing interface, icon management controller 240 may extract application information corresponding to each app icon selected through the icon managing interface from the app information storage 210, and may control the extracted application information to be transferred to the app information classification controller 220.

The display controller 250 controls each app icon to be displayed on the screen of the apparatus per group according to group determining information of the app icon group determiner 230. The display controller 250 may control at least one app icon classified into the same group according to the group determining information to be arranged and displayed according to a predetermined arrangement rule.

The arrangement rule may include a date and/or a time at which an application corresponding to the corresponding app icon, a date and/or a time at which the application was recently executed, data capacity of the application, the execution number of the application, and the like, but it is not limited thereto.

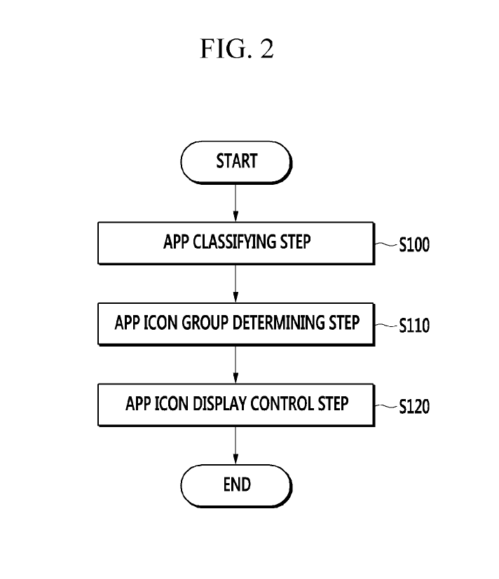

FIG. 2 is a flowchart showing an app icon managing method in accordance with the present exemplary embodiment.

Referring to FIG. 2, the app icon managing method in accordance with the present exemplary embodiment includes an app classifying step S100 for performing an application classifying process according to application information based on a predetermined classification rule, an app icon group determining step S110 for determining a group for at least one app icon based on result information of the application classifying process, and an app icon display controlling step S120 for controlling the display of the app icon on a screen thereof based on group determining information of the app icon.

For easy description, the app icon managing method of the present exemplary embodiment is described to be performed in the order as shown in FIG. 2, but performance procedure of each step may be changed, two or more steps may be combined, or one step may be divided into two or more steps without departing from the essential characteristics of exemplary embodiments.

In the meantime, in the app icon managing apparatus of the present exemplary embodiment, the app information classification controller 220 classifies the app information according to a predetermined classification rule as described above. For example, the classification rule may include at least one of a creator of the application, a genre into which the application is classified, a service platform for providing the application, and the execution number of the application, but it is not limited thereto.

Hereinafter, the classification rule that is applicable to the app information classification controller 220 and an app information classification method according to the classification rule will be described in more detail through the following examples. In this case, an app information classification and a display control method according to the group determination will be described later with reference to the accompanying drawings.

### Example 1-1

### Creator of Application

In the app icon managing apparatus in accordance with the present exemplary embodiment, the app information classification controller 220 may classify application information by using the creator of the application as the classification rule.

When the creator of the application is determined as the classification rule, the icon management controller 240 may extract application information corresponding to each target application icon to be classified from the app information storage 210. In this case, metadata may be applied as the application information, and the icon management controller 240 may extract metadata of each application from the app information storage 210.

The app information classification controller 220 classifies metadata having the same creator information based on the meta data.

In other words, the app information classification controller 220 can recognize creator information of the application from the metadata. For example, when information of creators A, B, and c are extracted from the metadata, the app information classification controller 220 can classify first metadata including the information of the creator A, second metadata including the information of the creator B, and third metadata including the information of the creator C.

Further, the app information classification controller 220 can generate application classifying processing result information by which the first metadata classified as including the information of the creator A, the second metadata classified as including the information of the creator B, and the third metadata classified as including the information of the creator C are divided.

The app icon group determiner 230 determines a group for an app icon corresponding to the metadata classified per creator based on the application classifying processing result information generated according to the process result by the app information classification controller 220.

For example, the app icon group determiner 230 can determine a first group for an app icon corresponding to the first metadata classified as including the information of the creator A. Similarly, the app icon group determiner 230 can determine a second group for an app icon corresponding to the second metadata classified as including the information of the creator B, and the app icon group determiner 230 can determine a third group for an app icon corresponding to the third metadata classified as including the information of the creator B.

The app icon group determiner 230 may determine a group according to the number of the metadata having the same creator information based on the application classifying processing result information.

Specifically, the app icon group determiner 230 can recognize the numbers of the first metadata classified as including the information of the creator A, the second metadata classified as including the information of the creator B, and the third metadata classified as including the information of the creator C, based on the application classifying processing result information, and may determine a group only for the metadata classified per creator of which the number is equal to or greater than a predetermined reference value.

For example, the app icon group determiner 230 may recognize that the number of the first metadata classified as including the information of the creator A is equal to or greater than the reference value, and the numbers of the second and third metadata respectively classified as including the information of the creators B and C are smaller than the reference value.

Accordingly, the app icon group determiner 230 may determine the first group only for an app icon corresponding to the first metadata classified as including the information of the creator A, but may determine no group for the second and third metadata respectively classified as including the information of the creators B and C.

Alternatively, the app icon group determiner 230 may determine a second group for both of the first metadata classified as including the information of creator A and the second metadata classified as including the information of creator B.

The display controller 250 may control app icons to be grouped and displayed on the screen of the apparatus based on the group determination information generated in the app icon group determiner 230.

Specifically, the display controller 250 can control at least one app icon determined to pertain to the first group to be displayed per group such that a user intuitively recognize the corresponding application pertains to the first group based on the group determination information. Similarly, the display controller 250 can control at least one app icon determined to pertain to the second or third group to be displayed per group such that a user intuitively recognize the corresponding application pertains to the second or third group based on the group determination information.

### Example 1-2

### Genre to which Application Pertains

In the app icon managing apparatus in accordance with the present exemplary embodiment, the app information classification controller 220 may classify application information by using the genre of the application as the classification rule.

In an embodiment, the genre indicates a particular function, style, or form used as the reference for classifying the application into the same group based on similar function or expressive elements. For example, the application information may include genre information of the application that is classified according to a document editorial function, a multimedia playback function, a game playing function, and the like.

Accordingly, when the genre of application is determined as the classification rule, the icon management controller 240 may extract application information (e.g., meta data) corresponding to each target application icon to be classified from the app information storage 210.

The app information classification controller 220 classifies the application information having the same genre information based on the application information.

For example, when information of genres A, B, and c are extracted from the application information, the app information classification controller 220 can classify first application information including the information of the genre A, second application information including the information of the genre B, and third application information including the information of the genre C.

Further, the app information classification controller 220 can generate application classifying processing result information by which the first application information classified as including the information of the genre A, the second application information classified as including the information of the genre B, and the third application information classified as including the information of the genre C are divided, and the app icon group determiner 230 determines a group for an app icon corresponding to the application information classified per genre based on the application classifying processing result information generated according to the process result by the app information classification controller 220.

The app icon group determiner 230 and the display controller 250 respectively perform similar operations according to the application classifying processing result information and the group determination information of the app icon group determiner 230 to those of the example 1-1, and thus detailed descriptions thereof will be omitted.

### Example 1-3

### Distributor, Service Platform

In the app icon managing apparatus in accordance with the present exemplary embodiment, the app information classification controller 220 may classify application information base on distributor information of the application or service platform information of the application.

In other words, applications installed in the apparatus may have same creator information but different distributor information, or may have different creator information, but same distributor information.

Further, the application may be differently embodied according to service platforms or operating system (OS) types of the apparatus. For example, “A” application may be embodied as a Window version, a mac version, a Linux version, an IOS version, an android version, or the like according to the OS types. As another example, the “A” application may be embodied as an olleh market version, a chaton version, a kakao talk version, a line version, or the like according to the service platforms of the application.

Accordingly, when the distributor or the service platform is determined as the classification rule, the icon management controller 240 may extract application information corresponding to each target application icon to be classified from the app information storage 210.

In this case, the application information may include the distribution information or service platform information, or may include information of a download path through which installation data of the application is received from an external server if necessary.

In the case of a mobile terminal, the download path may be changed according to the type of an OS such as iOS or android or the type of a market for providing an application. Accordingly, it is possible to recognize from which application server installation data of the application is received based on the download path information, and the distributor or the service platform can be recognized based thereon.

In the app icon managing apparatus of the present exemplary embodiment, the icon management controller 240 can acquire download path information while receiving installation data of the application and store it in the app information storage 210 to use it as app information corresponding to the corresponding application.

The app information classification controller 220 classifies the application information having the same distributor or service platform information based on the application information

For example, when information of service platforms A, B, and c are extracted from the application information, the app information classification controller 220 can classify first application information including the information of the service platform A, second application information including the information of the service platform B, and third application information including the information of the service platform C.

Further, the app information classification controller 220 can generate application classifying processing result information by which the first application information classified as including the information of the service platform A, the second application information classified as including the information of the service platform B, and the third application information classified as including the information of the service platform C are divided, and the app icon group determiner 230 determines a group for an app icon corresponding to the application information classified per genre based on the application classifying processing result information generated according to the process result by the app information classification controller 220

The app icon group determiner 230 and the display controller 250 respectively perform similar operations according to the application classifying processing result information and the group determination information of the app icon group determiner 230 to those of the example 1-1, and thus detailed descriptions thereof will be omitted.

When the app icon managing apparatus in accordance with the present exemplary embodiment receives installation data of the application from the external server, a network for providing connection to receive and transmit between the apparatus and the external server may be a closed network such as LAN or WAN, but may be an open network such as Internet. When the apparatus is a mobile terminal, the network may include a wireless access network such as a mobile communication network or a WiFi network.

### Example 1-4

### Execution Number

In the app icon managing apparatus in accordance with the present exemplary embodiment, the app information classification controller 220 may classify application information by using the (cumulative) execution number of the application as the classification rule.

In this case, the application information may be preferably usage history information for recognizing how many times the corresponding icon is selected for executing the application or how many times the application is executed.

Accordingly, when the execution number of the application is determined as the classification rule, the app information classification controller 220 can extract execution number information from the application information.

The execution number information may include a cumulative execution number of the application after the application is installed in the apparatus, but it is limited thereto. Alternatively, the execution number information may include a cumulative execution number of the application during a time period that is determined by calculating it back based on a time point at which an operation for controlling the display of an app icon by using the execution number as the classification rule according to the present exemplary embodiment.

The app information classification controller 220 may classify each application information according to predetermined reference values of the execution number. For example, when the reference values are determined as 10 and 50, the app information classification controller 220 may perform a classifying process on the application information for the execution number that is determined to be equal to or smaller than 10, the application information for the execution number that is determined to be greater than 10 and equal to or smaller than 50, and the application information for the execution number that is determined to be greater than 50.

The app information classification controller 220 may generate an application classifying processing result information according to the classification result, and the app icon group determiner 230 may determine a group for an app icon corresponding to the application information classified according to the reference values based on the application classifying processing result information generated according to the processing result of the app information classification controller 220.

The app icon group determiner 230 and the display controller 250 respectively perform similar operations according to the application classifying processing result information and the group determination information of the app icon group determiner 230 to those of the example 1-1, and thus detailed descriptions thereof will be omitted.

In the app icon managing apparatus of the present exemplary embodiment, one classification rule or two or more classification rules may be applied so that each group determined by the app icon group determiner 230 has a hierarchy structure.

Hereinafter, a method for allowing the display controller 250 to control the display of each app icon of which the group is determined in the app icon managing apparatus of the present exemplary embodiment will be described in detail.

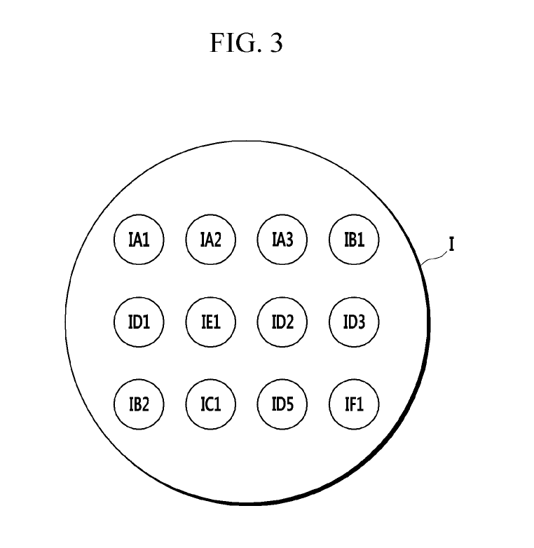

FIG. 3 shows an example of a target app icon to be managed in the app icon managing apparatus of the present exemplary embodiment.

An app icon set I shown in FIG. 3 includes an example of app icons corresponding to application information classified based on application classifying processing result information generated after the app information classification controller 220 performs an application classifying process according to application information in the app icon managing apparatus of the present exemplary embodiment.

### Example 2-1

### Folder Display

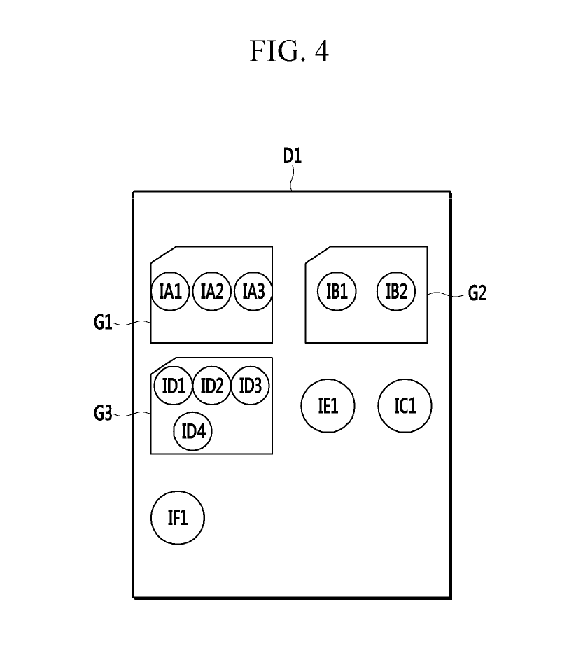

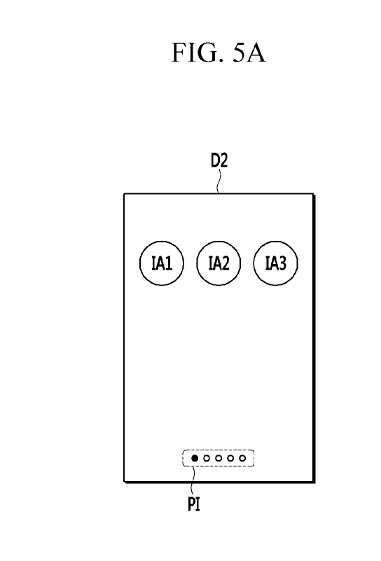

FIG. 4 is an exemplary view showing a screen of the app icon managing apparatus of the present exemplary embodiment for the app icons shown in FIG. 3.

Referring to FIG. 4, the app icon group determiner 230 determines a group for app icon corresponding to application information classified based on application classifying processing result information in the app icon managing apparatus of the present exemplary embodiment.

Referring to FIG. 4, the app icon group determiner 230 of the present exemplary embodiment determines a first group G1 for app icons IA1, IA2, and IA3, a second group G2 for app icons IB1 and IB2, and a third group G3 for app icons ID1, ID2, ID3, and ID4 to generate group determination information.

Further, in the case of an app icon IC1, an app icon IE1, and an app icon IF1, no group may be individually determined as described in Example 1-1, a predetermined default group may be assigned for all the remaining app icons, or a fourth group may be determined therefor according to the aforementioned examples.

When displaying a group on a display region of a screen of a terminal based on the group determination information, the display controller 250 may display a predetermined representative image and control app icons classified into the same group to be overlappingly displayed within the representative image.

For example, when three groups are determined based on the group determination information, the display controller 250 may control three representative image to be displayed on an apparatus screen D1. Further, the display controller 250 may control the app icons IA1, IA2, and IA3 classified into the first group G1, the app icons IB1 and IB2 classified into the second group G2, and the app icons ID1, ID2, ID3, and ID4 classified into the third group G3 to be respectively displayed on first, second, and third representative images by assigning the groups to each representative image.

Further, the display controller 250 may control the app icon IC1, the app icon IE1, and the app icon IF1 to be display at a region other than the regions at which the representative images are sequentially displayed by assigning coordinates thereto. If the fourth group is determined for the app icon IC1, the app icon IE1, and the app icon IF1, they may be controlled to be overlappingly displayed on a representative image, in a similar way to the first group G1.

Accordingly, it is possible to provide an effect that a user can intuitively recognize groups displayed on an apparatus screen and app icons pertaining to the groups as at least one app icons classified into the same group is displayed within a specific image according to the control of the display controller 250.

In this case, the display controller 250 may control only the representative images to be displayed per group and, if any one representative image is selected from a user, may control the app icons of the group corresponding to the selected representative image to be displayed.

### Example 2-2

### Display Per Page

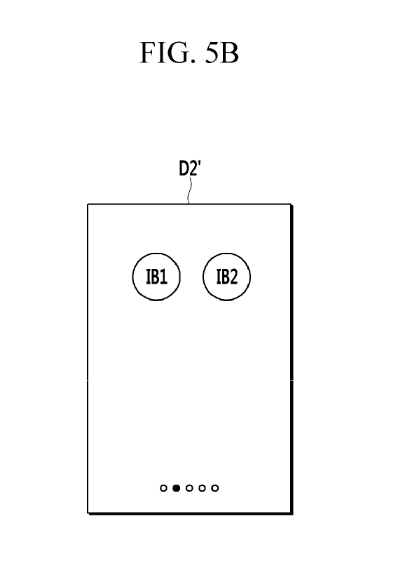

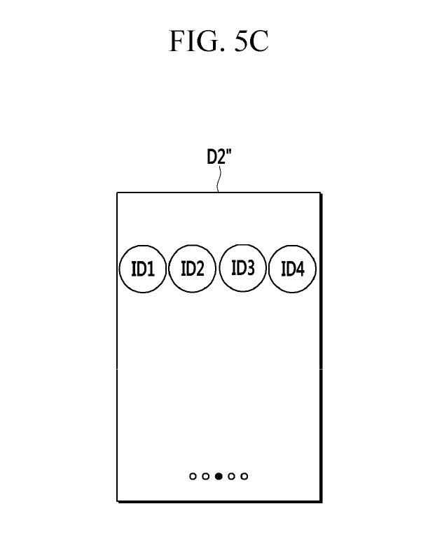

FIG. 5A to FIG. 5C exemplarily show a screen of the app icon managing apparatus of the present exemplary embodiment for the app icons shown in FIG. 3.

As described in the example 2-1, the app icon group determiner 230 of the present exemplary embodiment determines a first group a second group, and a third group for the respective app icons shown in FIG. 3 to generate group determination information.

Referring to FIG. 5A to FIG. 5C, the display controller 250 may assign apparatus screens to the groups based on the group determination information and control at least one app icons classified into the same group to be displayed on a corresponding one of the assigned apparatus screen.

For example, when three groups are determined based on the group determination information, the display controller 250 may form a plurality of pages at the display region of an apparatus screen and control the app icons pertaining to the same group to be displayed on one page by assigning the groups to each of the formed pages.

Accordingly, as shown in FIG. 5A to FIG. 5C, the display controller 250 may control the app icons IA1, IA2, and IA3 pertaining to the first group to be displayed on a first page D2. When a second page D2′ is displayed according to user manipulation, the app icons IB1 and IB2 pertaining to the second group may be controlled to be displayed on the second page D2′. Similarly, when a third page D2″ is displayed according to the user manipulation, the app icons ID1, ID2, ID3, and ID4 pertaining to the third group may be controlled to be displayed on the third page D2″.

In this case, the display controller 250 may control an identifier PI indicating the total number of the formed pages and a position of the current page to be displayed along with the corresponding app icons.

Further, as described in the example 2-1, the display controller 250 may additionally assign a fourth page to the app icons IC1, IE1, and IF1 and, if the fourth page is displayed according to the user manipulation, may control the app icons IC1, IE1, and IF1 to be displayed on the fourth page.

### Example 2-3

### Screen Dividing Display

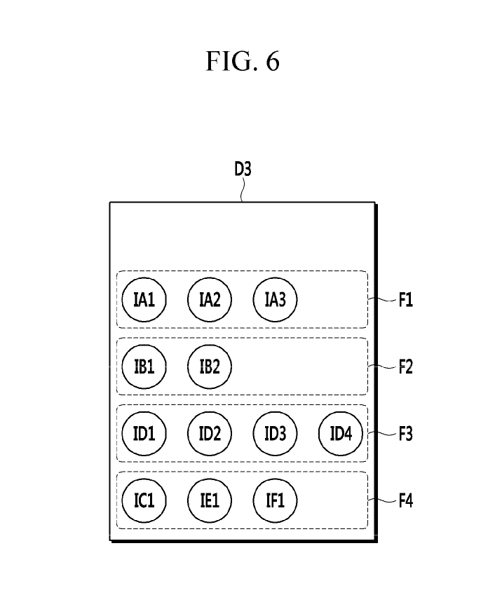

FIG. 6 is an exemplary view showing a screen of the app icon managing apparatus of the present exemplary embodiment for the app icons shown in FIG. 3.

As described in the example 2-1, the app icon group determiner 230 of the present exemplary embodiment determines a first group a second group, and a third group for the respective app icons shown in FIG. 3 to generate group determination information.

Referring to FIG. 6, the display controller 250 may divide a display region of the screen according to the number of the groups based on the group determination information and control at least one app icon classified into each of the groups to be display at the respective divided parts.

For example, when three groups are determined based on the group determination information and a default group is determined for the remaining app icons, the display controller 250 divides a display region of the apparatus screen into four parts for the four groups. Further, the display controller 250 may control at least one app icon classified into the same group to be displayed within the same part by assigning the groups to the respective divided parts.

Accordingly, when a screen D3 is divided into four areas, e.g., a first area F1, a second area F2, a third area F3, and a fourth area F4 for the four groups as shown in FIG. 6, the display controller 250 may control the app icons IA1, IA2, and IA3 pertaining to the first group, the app icons IB1 and IB2 pertaining to the second group, and the app icons ID1, ID2, ID3, and ID4 pertaining to the third group to be respectively display at the areas F1, F2, and F3.

Further, the display controller 250 may control the app icons IC1, IE1, and IF1 to be display at the fourth area F4.

In the meantime, two or more of the aforementioned examples may be combined. For example, when the examples 2-2 and 2-3 are combined, the display controller 250 may assign app icon groups to be displayed on one page thereto and divide the display region according to the number of the groups, and may control app icons of a group that is not assigned to be displayed on a new page.

As another example, the display controller 250 may control the app icons pertaining to the first group and the second group to be displayed on a first page, the app icons pertaining to the third group to be displayed on a second page, and the app icons pertaining to the fourth (default) group to be displayed on a third page.

In this case, the display controller 250 may divide the display region according to the number of the app icons pertaining to each group or assign pages thereto.

Meanwhile, in the app icon managing apparatus in accordance with the present exemplary embodiment, a new app icon that is not classified may be registered in an apparatus controller 20 after the installed app icons are subjected to the display control per group.

### Example 3

### The Case that an Icon is Updated

In the app icon managing apparatus in accordance with the present exemplary embodiment, the icon management controller 240 may control the display on a screen to be updated when a new app icon is registered in the apparatus (displayed on the screen) or an app icon that is displayed on the screen is deleted by a user.

Further, the icon management controller 240 may control the display on the screen to be updated by checking whether an unclassified app icon exists or whether deleted one of the classified app icons exists when it reaches a specific time according to a predetermined cycle.

The icon management controller 240 may also control the display on the screen to be updated by checking whether an unclassified app icon exists or whether deleted one of the classified app icons exists according to a user request.

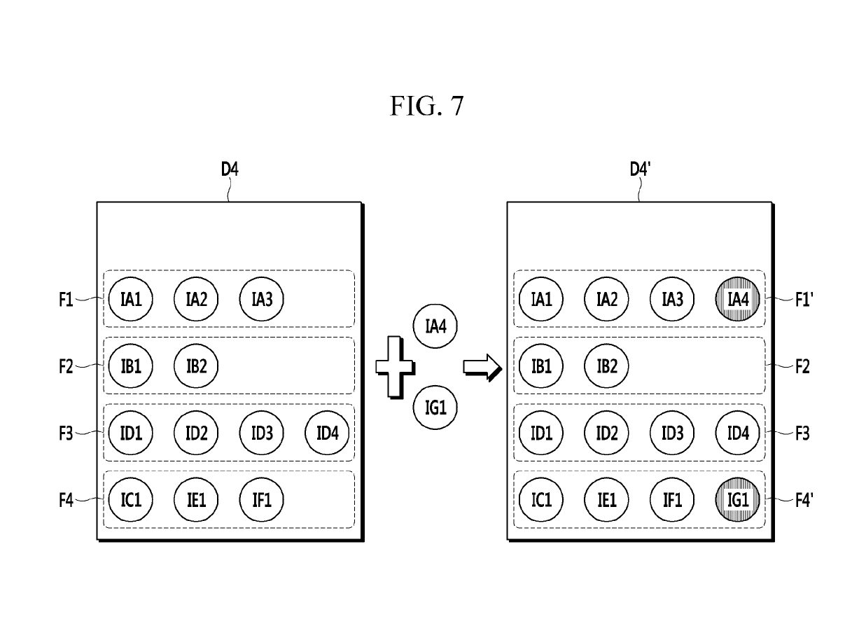

FIG. 7 exemplarily shows an apparatus screen of the app icon managing apparatus when an app icon is added in accordance with the present exemplary embodiment.

Referring to FIG. 7, in the app icon managing apparatus in accordance with the present exemplary embodiment, the icon management controller 240 check whether an app icon or application information that is not classified exists in addition to the app icons displayed per group based on group determination information

When application information that is not classified exists, the icon management controller 240 transfers the classified application information to the app information classification controller 220. Further, when an unclassified app icon exists, the icon management controller 240 acquires application information corresponding to the unclassified app icon and transfers it to the app information classification controller 220, and controls the acquired application information to be stored in the app information storage 210.

When the app icons IA4 and IG1 is derived according to a classifying processing result of the app information classification controller 220, the app icon group determiner 230 determines a group for each of the app icons IA4 and IG1 based on the application classifying processing result information.

When the app icon group determiner 230 determines the first group for the app icons IA4 and the fourth group for the app icon IG1, the app icon group determiner 230 control the app icons that are newly classified into the first group and the fourth group to respectively be added thereto by updating the group determination information.

The display controller 250 may control the app icon IA4 to be additionally displayed at the first area F1(F1′) at which the first group has been displayed and the app icon IG1 to be additionally displayed at the fourth area F4(F4′) at which the fourth group has been displayed on the apparatus screen D4(D4′).

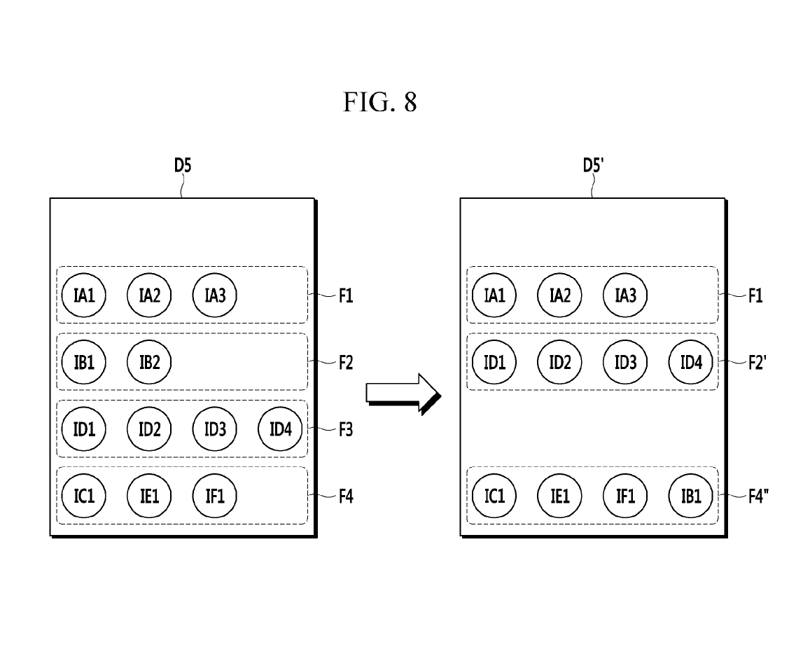

FIG. 8 exemplarily shows an apparatus screen of the app icon managing apparatus when an app icon is deleted in accordance with the present exemplary embodiment.

Referring to FIG. 8, in the app icon managing apparatus in accordance with the present exemplary embodiment, the icon management controller 240 check whether an app icon that is not displayed exists among the app icons displayed per group based on group determination information.

For example, as the result of checking, when it is checked that the app icon IB2 is not displayed within the second area F2 of an apparatus screen D5 as shown in FIG. 8, the icon management controller 240 may determine that the app icon IB1 is deleted by a user.

When it is determined that the app icon IB1 is deleted by a user, the icon management controller 240 identifies application information corresponding to the app icon IB2 and transfers the identified application information to the app icon group determiner 230.

The app icon group determiner 230 updates the group determination information by deleting information of the app icon IB2 therefrom based on the identified application and transfers the updated group determination information to the display controller 250.

In the meantime, as the app icon IB2 is deleted among the app icons IB1 and IB2 classified into the second group, it is determined that only the app icon IB1 exists in the second group. In this case, the app icon group determiner 230 may performs an updating process to change the app icons originally determined as the third group into the second group. Further, the app icon group determiner 230 may perform the updating process to change the app icons originally determined as the fourth group into the third group and add the app icon IB1 into the changed third group, and transfer the updated group determination information to the display controller 250.

The display controller 250 control the display to be updated based on the newly transferred group determination information.

The display controller 250 may control the app icons of the original third group to be display at the second area F2(F2′) at which the original second group has been displayed and the app icons of the changed third group to be display at the third area F3 at which the original third group has been displayed, based on the group determination information.

In this case, when the changed third group is a default group according to the group determination information, the display controller 250 may control the app icons of the changed third group to be displayed at the original fourth area F4″.

In the meantime, the display controller 250 may control a group identifier corresponding to each group classified based on the group determination information to be displayed on the screen together, and thus a user can recognize to which group each app icon pertains more clearly.

### Example 4

### Display of Group Identifier

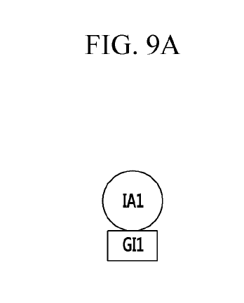

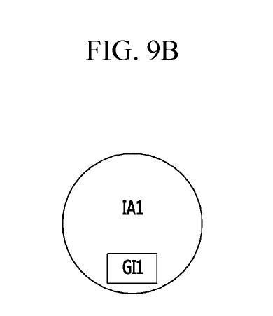

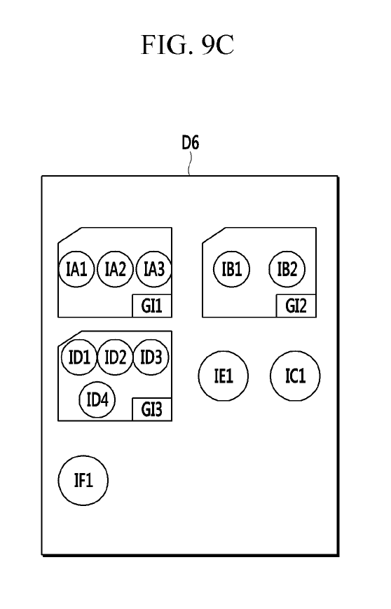

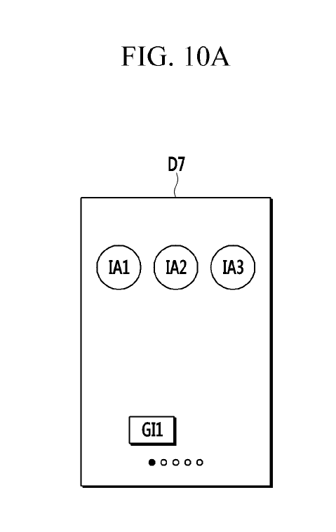

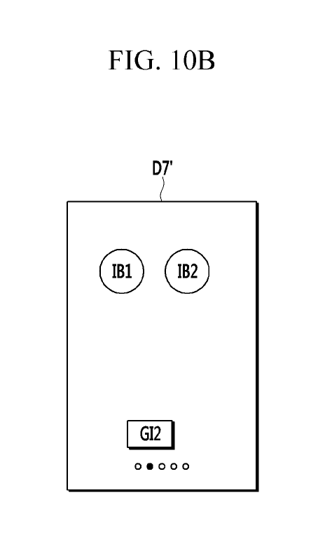

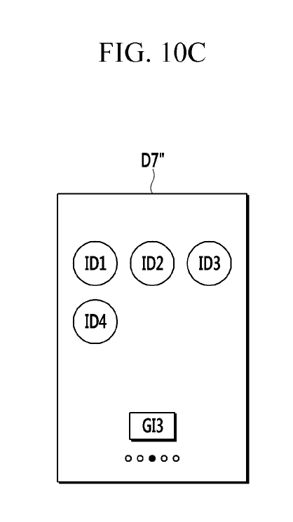

FIG. 9A to FIG. 10C are exemplary diagrams showing a screen of an app icon managing apparatus, displayed with a group identifier in accordance with yet another exemplary embodiment of the present invention.

The app icon group determiner 230 may determine group identifiers that are different per group according to application classifying processing result information or group determination information, and the display controller 250 may control each determined group identifier to be coupled to the corresponding app icon to be displayed.

Referring to FIG. 9A, the display controller 250 may control a group identifier GI1 determined for the first group to be disposed below the app icon IA1 classified into the first group to be displayed.

Referring to FIG. 9B, the display controller 250 may control the group identifier GI1 determined for the first group to be included in the app icon IA1 classified into the first group to be overlappingly displayed.

As shown in FIG. 9A or FIG. 9B, when the group identifier is displayed along with the corresponding app icon, the app icon may be applied to the display methods shown in FIG. 4 to FIG. 6.

The display controller 250 may also control the group identifier to be displayed on the screen to correspond to each group instead of controlling it to be overlappingly displayed with the corresponding app icon.

Referring to FIG. 9C, the display controller 250 controls as many representative images indicating the groups as the number of the groups to be displayed on an apparatus screen D6 and the groups to be assigned to each of the representative images to display the app icons pertaining to each of the assigned groups thereon. For example, as shown in FIG. 9C, the display controller 250 may control the group identifier GI1 determined for the first group to be displayed along with the corresponding app icons on the representative image displayed on the first group, a group identifier GI2 determined for the second group to be displayed along with the corresponding app icons on the representative image displayed on the second group, and a group identifier GI3 determined for the third group to be displayed along with the corresponding app icons on the representative image displayed on the third group.

Further, referring to FIG. 10A to FIG. 10C, when the display controller 250 assigns screen pages per group and controls the app icons pertaining to one group to be displayed on one page, the identifiers GI1, GI2, and GI3 can be controlled to be respectively displayed on the pages to which the groups are assigned.

For example, as shown in FIG. 10A to FIG. 10C, when the app icons pertaining to the first group is displayed on a first page D7 of the apparatus screen, the display controller 250 may control the group identifier GI1 determined for the first group to be displayed along with the corresponding app icons on the first page D7.

Similarly, when the app icons pertaining to the second group is displayed on a second page D7′ thereof, the display controller 250 may control the group identifier GI2 determined for the second group to be displayed along with the corresponding app icons on the second page D7′. Further, the display controller 250 may control the group identifier GI3 determined for the third group to be displayed along with the corresponding app icons on a third page D7″.

As such, when page identifiers are displayed on the respective pages, the group identifiers GI1, GI2, and GI3 may be respectively disposed adjacent above or below the page identifiers.

In the meantime, when each of the groups is determined according to a classification rule such as an application creator, a distributor, or a service platform, a specific image or text indicating the distributor or service platform of the application may be determined as the group identifier of each group.

For example, when an app icon corresponding to an application having a service platform A is classified to the first group, the app icon group determiner 230 may determine an image or text (e.g., Cl, logo, or trademark) indicating the service platform A as the group identifier of the first group. Further, when the app icons classified into the first group is controlled to be displayed on the screen, the group identifier of the first group can be controlled to be displayed along with the corresponding app icons.

In the meantime, the app icon group determiner 230 may control the group identifier of each group to be selected or inputted by a user through an icon managing interface.

For example, the app icon group determiner 230 may receive an input relating to which image or text is determined as the group identifier of each group for the groups that is determined or to be determined from a user.

Accordingly, the user can determine a desired image or text for each group of which app icons are automatically classified and displayed, thereby using the apparatus more conveniently.

The app icon managing method in accordance with the exemplary embodiment of the present invention as described above may be executed by the applications basically installed in the terminal (including programs included in a platform, an operating system, or the like which are basically installed in the terminal), and may also be executed by the applications (i.e., programs) which are directly installed in the terminal by the user via an application store server or an application store server such as a web server associated with the applications or the corresponding services

Herein, the operating system of the apparatus may be an operating system such as Window or Macintosh for a general personal computer such as a desk top computer or an mobile operating system such as iOS or Android for a smart phone or a tablet PC.

In this respect, the app icon managing method in accordance with the exemplary embodiment of the present invention may be implemented by the applications (i.e., programs) which are basically installed or directly installed by the user in the terminal and may be recorded in a computer readable recording medium of the terminal, and the like.

The app icon managing method in accordance with the exemplary embodiment of the present invention executes the function of performing an application classifying process according to application information by referring to a predetermined classification rule, the function of determining a group for at least one app icon based on application classifying processing result information, and the function of controlling the app icon to be display on a screen based on group determination information related to the app icon. In addition, it is possible to execute all functions corresponding to the aforementioned app icon managing method in accordance with the exemplary embodiment of the present invention by referring to FIG. 2 to FIG. 9C.

The programs are recorded in the computer readable recording medium and are executed by the computer, such that the above-mentioned functions may be executed.

As described above, in order for the computer to read the programs recorded in the recording medium and execute the method for providing the function of transferring character attribute information in the game implemented by the programs, the above-mentioned programs may include codes which are coded with computer languages such as C, C++, JAVA, machine language, and the like which may be read by a processor (CPU) of the computer.

The code may include a function code associated with a function of defining the above-mentioned functions and may also include an execution procedure related control code required for the processor of the computer to execute the above-mentioned functions according to a predetermined procedure.

Further, the code may further include a memory reference related code indicating at which location (address number) of the memory inside or outside the computer additional information or media required for the processor of the computer to execute the above-mentioned functions need to be referenced.

Further, in order for the processor of the computer to execute the above-mentioned functions, when the processor needs to communicate with any other computers or servers, etc. at a remote location, the code may further include a communication related code about how the processor of the computer communicates with any other computers or servers at a remote location or which information or media the processor of the computer transmits and receives at the time of the communication, by using the communication module (for example, wired and/or wireless communication module) of the computer.

Further, a functional program for implementing an embodiment, a code and a code segment associated therewith, and the like may be easily inferred or changed by programmers in the art to which an embodiment pertains in consideration of a system environment of the computer which reads the recording medium and executes the program.

Further, a computer readable recording medium recorded with programs as described above may be distributed to a computer system connected through a network and thus store and execute a computer readable code by a distributed manner. In this case, at least one computer among a plurality of distributed computers may execute a part of the above-mentioned functions and transmit the executed results to at least one of the other distributed computers, and the computer receiving the result may also execute a part of the above-mentioned functions and provide the executed results to the other distributed computers.

Hereinabove, examples of a computer readable recording medium recorded with programs for executing the app icon managing method in accordance with the exemplary embodiment of the present invention include a ROM, a RAM, a CD-ROM, a magnetic tape, a floppy disk, an optical media storage device, and the like

Examples of a computer readable recording medium recorded with applications, which are programs for executing the app icon managing method in accordance with the exemplary embodiment of the present invention may be a storage medium (for example, hard disk, and the like) included in an application store server or an application providing server such as a web server associated with applications or corresponding services, and the like, or the application providing server itself

A computer, which may read a recording medium recorded with applications that are programs for executing the app icon managing method in accordance with the exemplary embodiment of the present invention, may include not only a general PC such as a typical desktop and a laptop but also a mobile terminal such as a smart phone, a tablet PC, personal digital assistants (PDAs), and a mobile communication terminal, and is to be construed as all the computable devices

When a computer, which may read a recording medium recorded with applications that are programs for executing the app icon managing method in accordance with the exemplary embodiment of the present invention, is a mobile terminal such as a smart phone, a tablet PC, a personal digital assistant (PDA), and a mobile communication terminal, the applications are downloaded from an application providing server to a general PC and thus may also be installed in the mobile terminal through a synchronization program

Hereinabove, although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more component without departing from the scope of the present invention. In addition, although each of all the components may be implemented by one independent hardware, some or all of the respective components which are selectively combined with each other may be implemented by a computer program having a program module performing some or all of functions combined with each other in one or plural hardware. The codes and the code segments configuring the computer program may be easily inferred by a person having ordinary skill in the art to which the present invention pertains. The computer programs are stored in the computer readable media and are read and executed by the computer and may implement the exemplary embodiment of the present invention. As the storage medium of the computer programs, a magnetic recording medium, an optical recording medium, and the like may be used.

Further, it will be further understood that the terms “comprises” or “have” used in this specification may include the corresponding components unless explicitly described to the contrary and therefore, do not preclude other components but further include the components. In addition, unless defined otherwise in the detailed description, all the terms including technical and scientific terms have the same meaning as meanings generally understood by those skilled in the art to which the present invention pertains. Generally used terms such as terms defined in a dictionary should be interpreted as the same meanings as meanings within a context of the related art and should not be interpreted as ideally or excessively formal meanings unless clearly defined in the present specification.

The spirit of the present invention has been just exemplified. It will be appreciated by those skilled in the art that various modifications and alterations can be made without departing from the essential characteristics of the present invention. Accordingly, the exemplary embodiments disclosed in the present invention do not limit but describe the spirit of the present invention, and the scope of the present invention is not limited by the exemplary embodiments. The scope of the present invention should be interpreted by the following claims and it should be interpreted that all spirits equivalent to the following claims fall within the scope of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An app icon managing apparatus comprising:
an app information classification controller configured to perform an application classifying process according to application information by referring to a predetermined classification rule;
an app icon group determiner configured to determine a group for at least one app icon based on application classifying processing result information; and
a display controller configured to control the at least one app icon to be displayed on an apparatus screen based on group determination information related to the at least one app icon.

2. The app icon managing apparatus of claim 1, wherein the application information includes at least one of metadata of an application that is installed in the apparatus, data receiving path information of the application, and usage history information of the application.

3. The app icon managing apparatus of claim 1, wherein the app information classification controller performs the application classifying process according to the classification rule including at least one of a creator of the application, a genre into which the application is classified, a distributor of the application, a service platform of the application, and an execution number of the application.

4. The app icon managing apparatus of claim 1, wherein the display controller controls as many specific images as the number of the groups to be displayed based on the group determination information and the at least one app icon classified into a same group to be displayed within each of the displayed specific images.

5. The app icon managing apparatus of claim 1, wherein the display controller assigns different screens of the apparatus to each of the groups based on the group determination information, and controls the at least one app icon classified into a same group to be displayed on a corresponding assigned screen.

6. The app icon managing apparatus of claim 1, wherein the display controller divides a display region of the screen as many as the number of the groups based on the group determination information, and controls the at least one app icon classified into each of the groups to be displayed on a corresponding divided part.

7. The app icon managing apparatus of claim 1, wherein the display controller controls the at least one app icon classified into the same group to be arranged according to a predetermined arrangement rule to be displayed.

8. The app icon managing apparatus of claim 1, wherein the display controller controls a group identifier corresponding to each of the groups to be displayed on the screen based on the group determination information.

9. The app icon managing apparatus of claim 8, wherein the display controller controls the group identifier corresponding to each of the groups to be overlappingly displayed with each of the at least one app icon classified into a same group based on the group determination information.

10. The app icon managing apparatus of claim 1, wherein the app information classification controller performs the application classifying process for the application information selected by a user input.

11. An app icon managing method comprising:
an app information classification step configured to perform an application classifying process according to application information by referring to a predetermined classification rule;
an app icon group determining step configured to determine a group for at least one app icon based on application classifying processing result information; and
an app icon display control step configured to control the at least one app icon to be displayed on an apparatus screen based on group determination information related to the at least one app icon.

12. The app icon managing method of claim 11, wherein the app icon group determining step is performed by determining a group for a corresponding app icon based on application classifying processing result information performed for unclassified application information and updating the group determination information.

13. A computer readable recording medium recorded with program for executing an app icon managing method,
wherein the app icon managing method including:
an app information classification step configured to perform an application classifying process according to application information by referring to a predetermined classification rule;
an app icon group determining step configured to determine a group for at least one app icon based on application classifying processing result information; and
an app icon display control step configured to control the at least one app icon to be displayed on an apparatus screen based on group determination information related to the at least one app icon.
